(19) United States
(12) Patent Application Publication
(10) Pub. No.: US 2017/0291197 A1
(43) Pub. Date: Oct. 12, 2017

(54) METHOD AND COMPOSITION FOR CLEANING SURFACES

(71) Applicant: David D. Beaver, Jamestown, NY (US)

(72) Inventor: David D. Beaver, Jamestown, NY (US)

(21) Appl. No.: 15/482,232

(22) Filed: Apr. 7, 2017

Related U.S. Application Data
(60) Provisional application No. 62/319,600, filed on Apr. 7, 2016.

(51) Int. Cl. B08B 3/08

(52) U.S. Cl. CPC B08B 3/08

(57) ABSTRACT

A method of using hand cleaning compositions is provided. The hand cleaning compositions are provided separately, to be applied in sequence. In a first step of the method, a first liquid cleaning composition containing a low amount of detergent relative to moisturizer is applied to a surface to be cleaned. In a second step of the method, a second liquid cleaning composition containing a high amount of detergent relative to moisturizer is applied to the surface to be cleaned. The method provides an effective way to remove substances that typically soil skin, machinery or other common surfaces.

### CROSS REFERENCE OF RELATED APPLICATIONS

This application claims the benefits of U.S. provisional application No. 62/319,600, filed Apr. 7, 2016 and entitled METHOD AND COMPOSITION FOR CLEANING SURFACES, which provisional application is incorporated by reference herein in its entirety.

### FIELD

The present disclosure relates generally to a method of using liquid cleaning compositions. The method of the present disclosure is useful for cleaning surfaces including skin, vehicles, farm animals and industrial equipment.

### BACKGROUND

Frequent use of cleaning products can damage surfaces or irritate skin. To protect skin from damage caused by frequent washing, many common liquid skin cleaning products contain moisturizers, or are used in conjunction with a moisturizer after cleaning.

However, attempting to combine and mix moisturizers and hand cleaners, such as detergents, often leads to separation of the compositions, due to differing solubility or other chemical properties. Further, combining the hand cleaner with a moisturizer may lessen the effectiveness of the cleaner. A process required to maintain a homogenous formulation containing moisturizers and detergents in a hand cleaner may be costly or impractical.

Frequent use of soap can also become expensive, particularly when the user is involved in an activity that causes regular soiling of surfaces, such as farming or machine-related work.

Accordingly, there is a need for a method to clean surfaces that lessens the quantity of material used, lessens the time required for cleaning, and reduces damage or irritation to surfaces that require cleaning.

### SUMMARY

The method of using two different cleaning compositions described in the present disclosure improves the efficiency of cleaning surfaces and reduces damage caused to surfaces cleaned. The method utilizes two different cleaning compositions, to be used in sequence. The cleaning compositions to be used with the present disclosure are supplied in two separate containers, to be used one after the other. The first cleaning composition contains a lower ratio of detergent to moisturizer, while the second cleaning composition contains a higher ratio of detergent to moisturizer. The first cleaning composition may also be referred to as having light detergent and heavy moisturizer. The second cleaning composition may also be referred to as having heavy detergent and light moisturizer.

Neither of the compositions of the present disclosure contains a solvent. Solvents are difficult to remove through rinsing and solvents may irritate or dry skin after use. The cleaning compositions used according to the method of the present disclosure will not cause excessive dryness or irritation to the skin. The method is unexpectedly effective at removing common substances that may soil or stain a surface, such as oil, grease, and manure, and use of the two compositions, according to the present disclosure, provides a synergistic effect on cleaning.

The cleaning compositions of the method of the present disclosure may be colored and stored in translucent or transparent containers in order to identify the sequence in which the compositions should be applied. The method of the present disclosure can remove a wide variety of types of soils and stains, and is not limited in use or effectiveness to hands, although hand cleaning is one preferred use of the method of the present disclosure. Machines, animals and all surfaces that require cleaning may also be effectively cleaned by the method disclosed herein.

### DETAILED DESCRIPTION

The multi-step cleaning method of the present disclosure comprises at least two steps, where in the first step a first cleaning composition containing a lower ratio of detergent to moisturizer is applied, while in the second step, a second cleaning composition containing a higher ratio of detergent to moisturizer is applied. Other limitations of the compositions and methods of the present disclosure, as well as optional ingredients suitable for use herein, are described in detail hereinafter.

The term “multi-step” as used herein, means that different cleaning compositions disclosed herein are applied chronologically as separate steps. The sequence in which they are applied is important to the functioning of the method. Each composition may preferably have a distinctly different color, such that the colors may be associated with the steps of the method in a code. In one preferred embodiment of the present disclosure, the “multi-step” personal cleansing compositions are supplied in clear plastic bottles wherein the different colors of the two compositions are visible to a user through the bottle.

The term “cleansing composition” as used herein, refers to compositions intended for topical application to the skin, or to any surface in need of cleaning.

The cleaning compositions of the present disclosure are typically in the form of a liquid. The term “liquid” as used herein means that the composition is generally flowable to some degree. “Liquids”, therefore, can include liquid, semi-liquid, cream, lotion or gel compositions intended for topical application to skin.

The personal cleansing compositions and methods of the present disclosure can comprise, consist of, or consist essentially of, the essential elements and limitations of the disclosure described herein, as well as any additional or optional ingredients, components, or limitations described herein or otherwise useful in personal cleansing compositions intended for topical application to the hair or skin.

In broad terms, the present disclosure describes a method of use for two compositions comprising a set of two hand soap concentrates. The hand soap concentrates to be used with the present disclosure may come in two separate bottles. The first contains a mild detergent and strong moisturizer and the second contains a strong detergent and mild moisturizer. The ratio of detergent to moisturizer of the first cleaning composition is lower than that of the second.

The first and second cleaning compositions are of different colors, such that they can be easily recognized to ensure proper sequence of application. The first, for example, may be pink, while the second, for example, may be yellow.

The compositions are substantially free of solvents.

In the method of the present disclosure, hands are first wetted. Next, a first cleaning composition, which in the preferred embodiment is a pink colored composition produced by Arrow Chemical™ (Product #363), is applied to the hands in an amount approximating ⅜ of an ounce. Once applied, the palms of the hands are thoroughly rubbed together until the first composition is thoroughly distributed across the palms.

Next, a second cleaning composition, which in a preferred embodiment is a yellow colored cleaning composition supplied by Southwest Commercial Products™ having the trade name Super Tough Hand Scrub™, is applied in approximately an equal amount, here ⅜ of an ounce, and, as before, the hands are thoroughly rubbed together until the second cleaning composition is evenly distributed across the palms and mixed with the first cleaning composition. One advantage of the present disclosure is that only an initial wetting of the hands prior to addition of the cleaners is necessary; no further water is necessary during the process until the cleaning compositions are rinsed off. Water is then added to rinse and remove the cleaning compositions and the soil.

The first cleaning composition is supplied by Arrow Chemical™ and has a product number of 363. The first cleaning composition may be described as a concentrated, high suds, hand and body cleaner made from mild synthetic detergents and pH balanced. In the first cleaning composition the ratio of detergents to moisturizers is low, relative to the second cleaning composition of the method of the present disclosure. The color of the first composition, in a preferred embodiment, is pink. An important feature of the method of the present disclosure is that the first cleaning composition and second cleaning composition are of distinctly different colors.

The second cleaning composition in the method of the present disclosure is comprised of a strong and/or heavy detergent and mild and/or light moisturizer; the ratio of detergent to moisturizer is relatively high in the second cleaning composition when compared to the first. The second cleaning composition may be, in the preferred embodiment, supplied by Southwest Commercial Products™ and may be a product having the trade name Super Tough Hand Scrub™. Super Tough Hand Scrub™ hand cleaner is a popular, detergent-based, heavy-duty industrial hand cleaner and is comprised of a strong and/or heavy detergent and mild and/or light moisturizer.

Odor neutralizers, rather than a perfume or scent, may be added to at least one of the compositions in the preferred embodiment. Plastic scrubbers may be included in one embodiment of the present disclosure.

The method of the present disclosure conserves soap by preventing slippage of material off the hands and into the sink, as occurs with many comparable products. The thickness and texture of the composition of the first cleaning composition is such that it reduced the amount of hand cleaner that falls into the sink with the first motion of washing when compared to conventional hand soaps. The first step in the method is so rich in moisturizers it greatly reduced the need to add more water while washing. Further, the formulation of the present disclosure is more effective than high cost products and can be produced at a much lower cost.

### EXAMPLES

### Example 1

Example 1 shows a permanent marker test, which was performed using the method of the present disclosure (the method) and compared against three competing products, listed below in Table 1 as Products B-D.

TABLE 1

| | Name | Price Range |
|---|---|---|
| Product A | The method | Low |
| Product B | Goop ™ | Low |
| Product C | Gojo ™ | Mid |
| Product D | Majic ™ | High |

Test Procedure:

A 1.5 inch mark was made on the palm of the left hand with a standard permanent marker. The mark left by the permanent marker was then allowed to dry for one minute. The surface containing the mark was then cleaned using products A-D for one minute. After cleaning, the surface was then further washed with warm water for one minute. The surface was then rinsed under cold running water.

A visual assessment of the residual soiling (RS) on the palm surface was made according to the scale below:

1=no cleaning effect. 10=clean. Gradation in steps of 0.5 was considered.

The results of the permanent marker test are shown in Table 2 below.

TABLE 2

| | Score | Description |
|---|---|---|
| Product A | 10 | Mark was completely gone after 30 sec. of |
| | | cleaning. |
| Product B | 3 | Most of the marker was still visible after |
| | | cleaning. |
| Product C | 5 | ⅓ of mark visible after cleaning. |
| Product D | 9 | Trace of the mark remained after cleaning. |

### Example 2

Example 2 shows a soiling test. The soil to be removed consisted of equal parts chain oil, gear oil and liquid cow manure.

Test Procedure:

A ¼ ounce of soiling mixture was applied to a test subject's hand. The soiling mixture was then thoroughly rubbed in and allowed to set for 5 minutes. Hands were the cleaned according to the following procedure: hands were wetted and ¾ oz cleaning composition was applied. The cleaning composition was added, followed by 45 seconds of washing. The hand was then rinsed. A visual assessment of the residual soiling (RS) on the back of the hand and the palm was then made according to the scale below as shown in Table 3.

1=no cleaning effect. 10=clean. Gradation in steps of 0.5 was considered.

Results:

TABLE 3

| | Score | Description |
|---|---|---|
| Product A | 10 | Hands were clean after 1 cleaning attempt. |
| Product B | 5 | Hands were clean after three repetitions of |
| | | procedure. |
| Product C | 4.5 | Some soil remained after three repetitions of |
| | | procedure. |
| Product D | 9 | Hands were clean after two repetitions of |
| | | procedure. |

One of skill in the art would understand the term “about” is used herein to mean that a concentration of “about” a recited percentage (%) produces the desired degree of effectiveness in the compositions and methods of the present disclosure. One of skill in the art would further understand that the metes and bounds of “about” with respect to the concentration of any component in an embodiment can be determined by varying the concentration of one or more components (all percentages listed herein are by weight, as would be understood by one of ordinary skill in the art), determining the effectiveness of the mixture for each concentration, and determining the range of concentrations that produce mixtures with the desired degree of effectiveness in accordance with the present disclosure. The term “about” is further used to reflect the possibility that a mixture may contain trace components of other materials that do not alter the effectiveness or safety of the mixture.

It will be understood that emollients, humectants, fragrances, coloring agents, and other components may be added to or used with the compositions and methods provided herein. One of skill in the art can select additional components and determine suitable amounts and formulations such that the final composition functions with the desired degree of effectiveness to remove lacquer as provided herein.

The foregoing descriptions illustrate selected embodiments of the present disclosure and in light thereof various modifications will be suggested to one of skill in the art, all of which are in the spirit and purview of this disclosure.

What is claimed is:

1. A method of cleaning a surface comprising:
applying a first cleaning composition to the surface, wherein the first cleaning composition has a lower ratio of detergent to moisturizer than a second cleaning composition;
applying a second cleaning composition to the surface, wherein the surface is covered with the first cleaning composition, wherein the second cleaning composition has a higher ratio of detergent to moisturizer than the first cleaning composition; wherein the second cleaning composition forms a mixture with the first cleaning composition; and
removing the mixture from the surface.

2. The method of claim 1, wherein the first cleaning composition is of a different color than the second cleaning composition.

3. The method of claim 2, wherein the color of the first cleaning composition signifies that the first cleaning composition should be applied first.

4. The method of claim 1, wherein the first cleaning composition is a liquid and the second cleaning composition is a liquid.

5. The method of claim 1, wherein the first cleaning composition is solvent-free and the second cleaning composition is solvent-free.

6. The method of claim 1, wherein the first cleaning composition is of a viscosity such that the first cleaning composition does not slide off a hand.

7. The method of claim 1, wherein at least one of the first cleaning composition and the second cleaning composition contains scrubbers comprised of a solid material.

8. The method of claim 1, wherein the first cleaning composition is applied to the surface and left in contact with said surface for a prescribed period of time and the second cleaning composition is applied to the surface containing the first cleaning composition such that the first cleaning composition and the second cleaning composition form a mixture and the mixture is left in contact with the surface for a prescribed period of time.

9. The method of claim 1, wherein the first cleaning composition is of a first color and the second cleaning composition is of a second color and the first cleaning composition and the second cleaning composition are contained in a container that is transparent.

10. The method of claim 1 wherein the mixture is removed by rinsing.

11. A method of cleaning a surface comprising:
applying a first cleaning composition to the surface, wherein the first cleaning composition has a lower ratio of detergent to moisturizer than a second cleaning composition;
applying a second cleaning composition to the surface, wherein the surface is covered with the first cleaning composition, wherein the second cleaning composition has a higher ratio of detergent to moisturizer than the first cleaning composition; wherein the second cleaning composition forms a mixture with the first cleaning composition; and
removing the mixture from the surface.

12. The method of claim 11, wherein the first cleaning composition is applied for at least 30 seconds and the second cleaning composition is applied for at least 30 seconds.

13. The method of claim 11 wherein the first cleaning composition and the second cleaning composition contain odor neutralizers.

14. The method of claim 11, wherein the first cleaning composition is applied to a surface and left in contact with said surface for a prescribed period of time and the second cleaning composition is applied to the surface containing the first cleaning composition such that the first cleaning composition and the second cleaning composition form a mixture and the mixture is left in contact with the surface for a prescribed period of time.

15. The method of claim 11, wherein after the mixture is left in contact with the surface for a prescribed period of time, the mixture is removed from the surface.

16. The method of claim 11, wherein the detergent is a surfactant.

17. The method of claim 11, wherein first cleaning composition is high in moisturizer content such that it greatly reduced the need to add more water while washing.

18. A method of cleaning a surface comprising:
applying a first cleaning composition to the surface, wherein the first cleaning composition has a lower ratio of detergent to moisturizer than a second cleaning composition;
applying a second cleaning composition to the surface, wherein the surface is covered with the first cleaning composition, wherein the second cleaning composition has a higher ratio of detergent to moisturizer than the first cleaning composition; wherein the second cleaning composition forms a mixture with the first cleaning composition; and
removing the mixture from the surface; wherein the first cleaning composition is of a first color and the second cleaning composition is of a second color; wherein the first cleaning composition and the second cleaning composition.

19. The method of claim 18, wherein the first cleaning composition is colored pink and the second cleaning composition is colored yellow.

20. The method of claim 18, wherein the mixture removes soil more effectively than the first cleaning composition alone.
